(19) United States
(12) Patent Application Publication
(10) Pub. No.: US 2017/0087807 A1
(43) Pub. Date: Mar. 30, 2017

(54) TOUCH PANELS, TOUCH DISPLAY DEVICES AND DISPLAY DEVICES

(71) Applicant: TPK Touch Solutions (Xiamen) Inc., Xiamen (CN)

(72) Inventors: Yuhwen Lee, Hsinchu County (TW); Jenchang Liu, Kaohsiung City (TW); Ruizhen Lin, Xiamen (CN); Jiangqiang Zhuang, Fuzhou (CN); Hongyan Lian, Xiamen (CN)

(21) Appl. No.: 15/281,062

(22) Filed: Sep. 29, 2016

(30) Foreign Application Priority Data
Sep. 29, 2015 (CN) 201510630853.8

(51) Int. Cl. B32B 7/12

(52) U.S. Cl. CPC B32B 7/12; B32B 2457/208; B32B 2307/54

(57) ABSTRACT

A touch panel includes a substrate, a cover glass disposed above the substrate, and an optical clear adhesive disposed between the substrate and the cover glass. The optical clear adhesive has an elastic modulus ranging from 1×10⁷ Pa to 1×10¹⁰ Pa. A touch sensing layer is disposed on an upper surface, a lower surface, or the upper surface and the lower surface of the substrate.

### TECHNICAL FIELD

The technical field relates to a touch panel, a touch display device, and a display device with high strength and good shatterproof performance.

### BACKGROUND

In some touch devices, the size of the touch panel (“TP”) is slightly larger than that of the liquid-crystal display module (“LCM”) in order to make follow-up assembly easier. The TP and LCM are generally bonded to each other through optical clear adhesive (“OCA”).

### SUMMARY

In accordance with at least one embodiment of the disclosure, a touch panel is provided. The touch panel comprises a substrate; a cover glass disposed above the substrate; an optical clear adhesive disposed between the substrate and the cover glass, wherein the optical clear adhesive has an elastic modulus ranging from 1×10⁷ Pa to 1×10¹⁰ Pa; and a touch sensing layer disposed on an upper surface or a lower surface of the substrate or the upper surface and the lower surface of the substrate.

In accordance with at least another embodiment of the disclosure, a touch display device is provided. The touch display device comprises a display module; a touch panel disposed above the display module; and a first optical clear adhesive disposed between the display module and the touch panel, wherein the first optical clear adhesive has an elastic modulus ranging from 1×10⁷ Pa to 1×10¹⁰ Pa.

In accordance with at least another embodiment of the disclosure, a display device is provided. The display device comprises a display module; a cover glass disposed above the display module; and an optical clear adhesive disposed between the display module and the cover glass, wherein the optical clear adhesive has an elastic modulus ranging from 1×10⁷ Pa to 1×10¹⁰ Pa.

The touch panel, the touch display device or the display device provided by the disclosure comprises the optical clear adhesive having greater elastic modulus. When an external force is applied on the such devices, the optical clear adhesive with such property is capable of absorbing most of the external force and decreasing the impact on the such devices from the external force therefore effectively improving the anti-drop strength of the related products and preventing the cover glass or the touch panel from edge breakage and glass debris shattering, reducing the likelihood of personal injury.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a cross-sectional view of a touch panel in accordance with at least one embodiment of the disclosure;

FIG. 2 is a cross-sectional view of a touch display device in accordance with at least one embodiment of the disclosure;

FIG. 3 is a cross-sectional view of a touch panel in accordance with at least one embodiment of the disclosure;

FIG. 4 is a cross-sectional view of a touch panel in accordance with at least one embodiment of the disclosure; and

FIG. 5 is a cross-sectional view of a display device in accordance with at least one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments are practiced without these specific details. In other instances, well-known structures and devices are schematically shown in order to simplify the drawings.

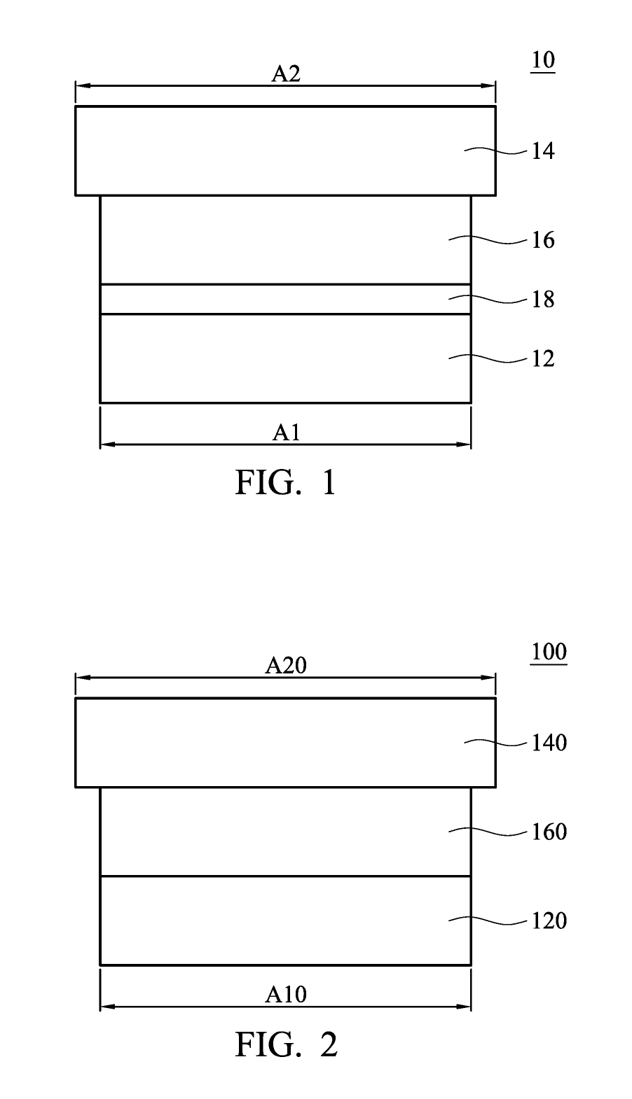

In accordance with at least one embodiment of the disclosure, a touch panel is described in FIG. 1. FIG. 1 is a cross-sectional view of the touch panel.

Referring to FIG. 1, a touch panel 10 is provided. The touch panel 10 comprises a substrate 12, a cover glass 14, an optical clear adhesive 16 and a touch sensing layer 18. As shown in FIG. 1, the cover glass 14 is disposed above the substrate 12. The optical clear adhesive 16 is disposed between the substrate 12 and the cover glass 14. The touch sensing layer 18 is disposed on an upper surface of the substrate 12. Additionally, a surface of the cover glass 14 away from the optical clear adhesive 16 provides users with touch operation. The upper surface of the substrate 12 is a surface of one side of the substrate 12 approaching the cover glass 14. Specifically, the optical clear adhesive 16 has an elastic modulus ranging from about 1×10⁷ Pa to about 1×10¹⁰ Pa, further, ranging from about 1×10⁸ Pa to about 1×10⁹ Pa.

In some embodiments, optionally, the touch sensing layer 18 is disposed on a lower surface of the substrate 12 (not shown), or the touch sensing layer 18 is simultaneously disposed on the upper surface and the lower surface of the substrate 12. The lower surface of the substrate 12 is a surface opposite to the upper surface thereof. The touch sensing layer 18 comprises uniaxial, biaxial/intersecting or multiaxial sensing electrodes.

In some embodiments, the cover glass 14 and the substrate 12 respectively comprise glass or sapphire.

In some embodiments, the optical clear adhesive 16 has stress at yield point greater than about 1×10⁷ Pa or greater than about 3×10⁷ Pa. The optical clear adhesive 16 has an elongation at break ranging from about 100% to about 200% or ranging from about 110% to about 150%. The mechanical properties of the optical clear adhesive 16 used in the touch panel 10 of the disclosure are distinct from those of conventional optical clear adhesive. The mechanical parameters (for example, elastic modulus, stress at yield point and elongation at break) between a conventional optical clear adhesive and the present optical clear adhesive 16 are tested through a stretching machine (stretching rate: 500 mm/min). The adhesion test (under room temperature of 26° C.) is also performed. The test results are shown in the following Table 1.

TABLE 1

| | | The present | Conventional | |
|---|---|---|---|---|
| | | optical clear | optical | |
| | Test projects | adhesive | clear adhesive | |
| Stretching rate | Elastic modulus (Pa) | 6.7 × 10⁸ | 2.0-9.0 × | 10³⁻⁴ |
| (500 mm/min) | Stress at yield point | 3.2 × 10⁷ | 1.0-5.0 × | 10⁶ |

| | | | |
|---|---|---|---|
| | (Pa) | | |
| | Elongation at break | 127 | 600-900 |
| | (%) | | |
| Room temperature | Adhesion (N) | 22.57-27.05 | 15.21-30.56 |

The test results from Table 1 demonstrate that the optical clear adhesive 16 in the touch panel 10 is capable of improving the anti-drop strength of the touch panel 10 and decreasing the breakage of the cover glass 14, mainly due to the optical clear adhesive 16 having greater elastic modulus and stress at yield point than the conventional optical clear adhesive. In general, the drop-ball test is used to evaluate the anti-drop strength of the touch panel, when the falling ball hits the surface of the cover glass 14 of the touch panel 10, the optical clear adhesive 16 is capable of providing good supporting force and stress-buffering effect for the touch panel 10, absorbing most of the impact from the external force against the cover glass 14 and making the steel ball rebound effectively therefore preventing the cover glass 14 from breaking or edge glass shatter. Furthermore, the optical clear adhesive 16 has lower elongation at break than that of the conventional optical clear adhesive which is capable of preventing the cover glass 14 from excessive deformation and breakage due to the external force.

In some embodiments, the optical clear adhesive 16 comprises adhesive resin material. The optical clear adhesive 16 is solid or liquid, or transparent material for coating. Specifically, when the mechanical properties of the resin material meets the specific elastic modulus (for example, ranging from 1×10⁷ Pa to 1×10¹⁰ Pa), stress at yield point (for example, greater than 1×10⁷ Pa) or elongation at break (for example, ranging from 100% to 200%), it is regarded as the optical clear adhesive material suitable for use in the disclosure.

In order to facilitate subsequent assembly, the area A1 of the optical clear adhesive 16 is approximately smaller than the area A2 of the cover glass 14, and approximately equal to the area of the substrate 12, avoiding the optical clear adhesive 16 protruding from the edge of the substrate 12 and adhering to particles in the air.

Referring to FIG. 2, a touch display device 100 is provided. The touch display device 100 comprises a display module 120, a touch panel 140 and a first optical clear adhesive 160. As shown in FIG. 2, the touch panel 140 is disposed above the display module 120. The first optical clear adhesive 160 is disposed between the display module 120 and the touch panel 140. Specifically, the first optical clear adhesive 160 has an elastic modulus ranging from about 1×10⁷ Pa to about 1×10¹⁰ Pa, or ranging from about 1×10⁸ Pa to about 1×10⁹ Pa.

In some embodiments, the display module 120 is a liquid-crystal display module.

In some embodiments, the first optical clear adhesive 160 comprises adhesive resin material. The first optical clear adhesive 160 has stress at yield point greater than about 1×10⁷ Pa or greater than about 3×10⁷ Pa. In some embodiments, the first optical clear adhesive 160 has an elongation at break ranging from about 100% to about 200% or ranging from about 110% to about 150%. The parameters of the first optical clear adhesive 160 are basically the same as those of the optical clear adhesive 16 in the embodiment of FIG. 1. The parameters of the first optical clear adhesive 160 and a conventional optical clear adhesive are compared in Table 1, and there will be no more discussion of this topic here.

In some embodiments, the first optical clear adhesive 160 is solid or liquid, or transparent material for coating. Specifically, when the mechanical properties of the resin material meets the specific elastic modulus (for example, ranging from 1×10⁷ Pa to 1×10¹⁰ Pa), stress at yield point (for example, greater than 1×10⁷ Pa) or elongation at break (for example, ranging from 100% to 200%), it is regarded as optical clear adhesive material suitable for use in the disclosure.

In order to facilitate subsequent assembly, the area A10 of the first optical clear adhesive 160 is approximately smaller than the area A20 of the touch panel 140, and approximately equal to the area of the display module 120, avoiding the first optical clear adhesive 160 protruding from the edge of the display module 120 and adhering to particles in the air.

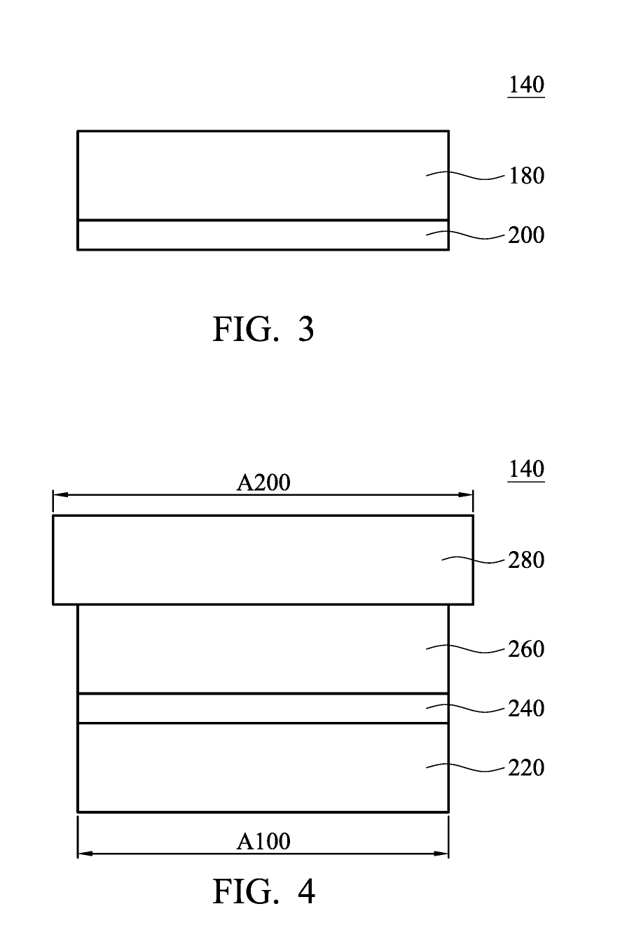

In some embodiments, the touch panel 140 comprises a cover glass 180 and a touch sensing layer 200, as shown in FIG. 3. The touch sensing layer 200 is disposed on a lower surface of the cover glass 180 to form a one glass solution (OGS) structure. In general, the strength of the touch panel 140 of such a one glass solution (OGS) structure is weaker than that of the touch panel 10 comprising two substrates in the embodiment of FIG. 1 due to the touch panel 140 merely comprising one substrate (i.e. the cover glass 180), being more likely to break when dropping or impacting. In particular, after the touch panel 140 is assembled with the display module 120, the strength of the touch panel 140 is more fragile due to the area A10 of the first optical clear adhesive 160 being approximately smaller than the area A20 of the touch panel 140 and approximately equal to the area of the display module 120 without covering the edge of the touch panel 140 by the first optical clear adhesive 160. In at least this embodiment, the first optical clear adhesive 160 with particular properties is adopted to bond the touch panel 140 and the display module 120. Due to the first optical clear adhesive 160 having greater elastic modulus and stress at yield point and lower elongation at break, when an external force is applied on the touch display device 100, the first optical clear adhesive 160 is capable of absorbing most of the external force and decreasing the impact on the touch display device 100 from the external force, therefore effectively improving the anti-drop strength of the touch display device 100 and preventing the touch display device 100 from edge breakage and glass debris shatter, reducing the likelihood of personal injury.

Besides, in a conventional one glass solution (OGS) touch panel, a hard coating film (HC film) is generally formed first on the surface of the touch sensing layer away from the cover glass, and then the touch panel is bonded to the display module using general optical clear adhesive to form the touch display device. Although the hard coating film is capable of increasing the strength of the touch display device to a certain extent, the anti-drop strength of the conventional touch display device incorporating the hard coating film and the general optical clear adhesive is still lower than that of the touch display device 100, mainly due to the elastic modulus and stress at yield point of the hard coating film combining with the general optical clear adhesive less than those of the first optical clear adhesive 160, respectively. In addition, the additional element, the hard coating film, in the structure of the conventional touch display device incorporating the hard coating film and the general optical clear adhesive makes the bonding workmanship more complicated. Compared to a conventional touch display device, the touch display device 100 not only simplifies the structure but also optimizes the manufacturing process which is capable of effectively decreasing the production costs.

In this embodiment, the cover glass 180 may comprise glass or sapphire.

In at least this embodiment, the touch sensing layer 200 comprises indium tin oxide (ITO), indium zinc oxide (IZO) or other suitable transparent material, for generating signals through touch.

In some embodiments, the touch panel 140 also comprises a substrate 220, a touch sensing layer 240, a second optical clear adhesive 260 and a cover glass 280. As shown in FIG. 4, the touch sensing layer 240 is disposed on an upper surface of the substrate 220. The cover glass 280 is disposed above the substrate 220. Additionally, the second optical clear adhesive 260 is disposed between the substrate 220 and the cover glass 280.

In some embodiments, the touch sensing layer 240 is also disposed on a lower surface of the substrate 220 (not shown), or simultaneously disposed on the upper surface and the lower surface of the substrate 220 (not shown).

In this embodiment, the cover glass 280 and the substrate 220 respectively comprises glass or sapphire.

In this embodiment, in order to further improve the strength of the touch display device 100, the second optical clear adhesive 260 having parameters the same as those of the first optical clear adhesive 160 is adopted. For example, the second optical clear adhesive 260 comprises adhesive resin material. The second optical clear adhesive 260 has an elastic modulus ranging from about 1×10⁷ Pa to about 1×10¹⁰ Pa, or ranging from about 1×10⁸ Pa to about 1×10⁹ Pa. The second optical clear adhesive 260 has stress at yield point greater than about 1×10⁷ Pa or greater than about 3×10⁷ Pa. The second optical clear adhesive 260 has an elongation at break ranging from about 100% to about 200% or ranging from about 110% to about 150%. The strength of the touch display device 100 is maximally improved by a collective effect of the first optical clear adhesive 160 and the second optical clear adhesive 260.

In this embodiment, the second optical clear adhesive 260 is solid or liquid, or transparent material for coating. Specifically, when the mechanical properties of the resin material meets the specific elastic modulus (for example, ranging from 1×10⁷ Pa to 1×10¹⁰ Pa), stress at yield point (for example, greater than 1×10⁷ Pa) or elongation at break (for example, ranging from 100% to 200%), it is regarded as the optical clear adhesive material suitable for use in the disclosure.

In this embodiment, the touch sensing layer 240 comprises indium tin oxide (ITO), indium zinc oxide (IZO) or other suitable transparent material.

In order to facilitate subsequent assembly, the area A100 of the second optical clear adhesive 260 is approximately smaller than the area A200 of the cover glass 280, and the area A100 of the second optical clear adhesive 260 is approximately equal to the area of the substrate 220, avoiding the second optical clear adhesive 260 protruding from the edge of the substrate 220 and adhering to particles in the air.

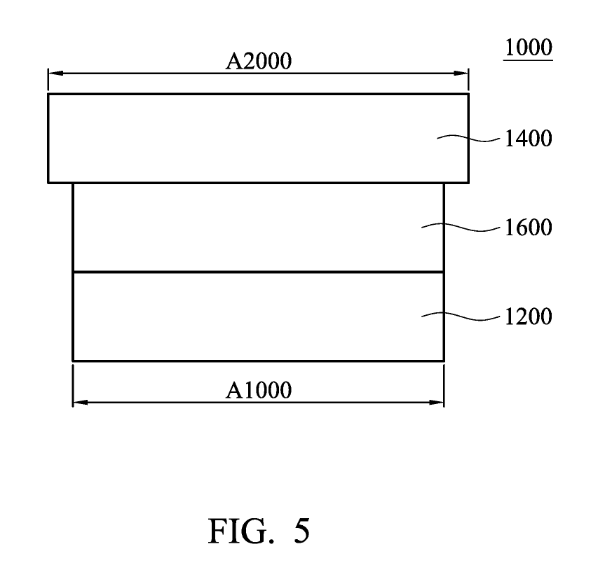

Referring to FIG. 5, a display device 1000 is provided. The display device 1000 comprises a display module 1200, a cover glass 1400 and an optical clear adhesive (OCA) 1600. As shown in FIG. 5, the cover glass 1400 is disposed above the display module 1200. The optical clear adhesive (OCA) 1600 is disposed between the display module 1200 and the cover glass 1400. Specifically, the optical clear adhesive (OCA) 1600 has an elastic modulus ranging from 1×10⁷ Pa to 1×10¹⁰ Pa, or ranging from about 1×10⁸ Pa to about 1×10⁹ Pa.

In some embodiments, the display module 1200 is a liquid-crystal display module.

In some embodiments, the cover glass 1400 comprises glass or sapphire.

The optical clear adhesive 1600 having parameters the same as those of the optical clear adhesive 16 in the embodiment of FIG. 1 are adopted. For example, the optical clear adhesive 1600 comprises adhesive resin material. The optical clear adhesive 1600 has stress at yield point greater than about 1×10⁷ Pa or greater than about 3×10⁷ Pa. The optical clear adhesive 1600 has an elongation at break ranging from about 100% to about 200% or ranging from about 110% to about 150%. Due to the optical clear adhesive 1600 having greater elastic modulus and stress at yield point and lower elongation at break, when an external force is applied on the display device 1000, the optical clear adhesive 1600 is capable of absorbing most of the external force and decreasing the impact on the display device 1000 from the external force therefore effectively improving the anti-drop strength of the display device 1000 and preventing the display device 1000 from edge breakage and glass debris shatter, reducing the likelihood of personal injury.

In some embodiments, the optical clear adhesive 1600 is solid or liquid, or transparent material for coating. Specifically, when the mechanical properties of the resin material meets the specific elastic modulus (for example, ranging from 1×10⁷ Pa to 1×10¹⁰ Pa), stress at yield point (for example, greater than 1×10⁷ Pa) or elongation at break (for example, ranging from 100% to 200%), it is regarded as the optical clear adhesive material suitable for use in the disclosure.

In order to facilitate subsequent assembly, the area A1000 of the optical clear adhesive 1600 is approximately smaller than the area A2000 of the cover glass 1400, and approximately equal to the area of the display module 1200.

The methods for fabricating the touch panel 10, the touch display device 100 and the display device 1000 of the disclosure comprise a cleaning step, a bonding step, and a deaerating step, here, the fabrication of the touch display device 100 as an example, while described with FIG. 2.

First, in the cleaning step, a first cleaning treatment is performed on the surface of the touch panel 140 and the display module 120 using a solvent such as alcohol. The touch panel 140 and the display module 120 are then placed in a plasma processing apparatus. A second cleaning treatment is performed on the surface of the touch panel 140 and the display module 120 to remove organics therefrom. The cleaning step is capable of removing dust and other particles from the surface to be bonded onto the touch panel 140 and the display module 120, avoiding affecting the bonding effect.

Next, the bonding step is performed. First, a bonding machine is heated to make its heating platform achieve a set temperature to perform the bonding between the touch panel 140 and the optical clear adhesive 160. The display module 120 is then bonded to the optical clear adhesive 160. In other embodiments, in order to improve the bonding effect between the optical clear adhesive 160 and the display module 120, another optical clear adhesive is optionally used between the optical clear adhesive 160 and the display module 120.

After the bonding step is completed, the deaerating step is performed to remove bubbles that form during the bonding step, which influences the appearance of the device.

In order to more clearly illustrate the device of the disclosure which possesses high strength and good explosion-proof performance, the strength test of the touch display device 100 in the embodiment of FIG. 2 is performed as follows.

### EXAMPLE 1

The falling tests of the present touch display devices and conventional touch display devices were performed and compared as follows. In order to ensure the reliability of the test results, the conventional touch display devices adopted general optical clear adhesive and the present touch display devices adopted the optical clear adhesive of the disclosure. Other structural elements were the same among such devices. Sample 1 and Sample 2 represented the present touch display devices, and Sample 3 and Sample 4 represented the conventional touch display devices.

TABLE 2

| Falling height | | | | |
|---|---|---|---|---|
| of ball | Sample 1 | Sample 2 | Sample 3 | Sample 4 |
| 30 cm | Unbroken | Unbroken | Unbroken | Unbroken |
| 50 cm | Unbroken | Unbroken | Broken | Broken |
| 100 cm | Unbroken | Unbroken | Broken | Broken |

The test results from Table 2 demonstrate that when the falling height was 30 cm, neither the conventional touch display devices nor the present touch display devices fractured. However, when the steel ball of the same weight was dropped from 50 cm and 100 cm, respectively, the edge glass of the conventional touch display devices (Sample 3 and Sample 4) was shattered. However, the present touch display devices (Sample 1 and Sample 2) remained intact without glass shatter. Thus it has been shown that the strength of the present touch display devices is apparently higher than that of conventional touch display devices.

### EXAMPLE 2

The falling tests of conventional touch display devices and the present touch display devices were performed and compared as follows. In the structure of the conventional touch display device, a one glass solution (OGS) touch panel, a hard coating (HC) film, general optical clear adhesive and a liquid-crystal display module were sequentially superimposed. The present touch display device 100 in the embodiment of FIG. 2 was selected as a test sample, wherein the one glass solution (OGS) touch panel 140 in the embodiment of FIG. 3 was selected. The falling tests (falling height: 100 cm) were performed on the conventional touch display devices (Sample 4 and Sample 5) and the present touch display devices (Sample 1, Sample 2 and Sample 3) respectively using steel balls of different weights (100 g, 130 g and 150 g). The test results are shown in Table 3.

TABLE 3

| | Sample 1 | Sample 2 | Sample 3 | Sample 4 | Sample 5 |
|---|---|---|---|---|---|
| Steel ball | 100 g/100 cm | 130 g/ | 150 g/100 cm | 100 g/100 cm | 130 g/100 cm |
| weight/Falling | | 100 cm + | | | |
| height | | 150 g/100 cm | | | |
| Falling times | 2 times | 130 g/ | 5 times | 1 time | 1 time |
| | | 10 times + | | | |
| | | 150 g/ | | | |
| | | 3 times | | | |
| Broken or not | Unbroken | Unbroken | Unbroken | Broken | Broken |

The test results from Table 3 demonstrate that when the steel ball with the same weight of 100 g was dropped from the same height of 100 cm against the present touch display device (Sample 1) twice, the present touch display device was not broken, however, the conventional touch display device (Sample 4) was fractured when dropped only once. Similarly, when the steel ball with the weight of 130 g was dropped from the height of 100 cm against the present touch display device (Sample 2) 10 times, and then the steel ball with the weight of 150 g was dropped from the height of 100 cm against the same touch display device (Sample 2) 3 times, the present touch display device was not fractured. Correspondingly, while the steel ball with the weight of 130 g was dropped from the height of 100 cm, the conventional touch display device (Sample 5) was fractured when dropped only once. When the steel ball with the weight of 150 g was dropped from the height of 100 cm against the present touch display device (Sample 3) 5 times, the present touch display device was not fractured. Apparently, according to the results of the falling tests cited above, the strength of the present touch display devices is higher than that of the conventional touch display devices incorporating the hard coating (HC) film.

The touch panel, the touch display device and the display device provided by the disclosure comprise the optical clear adhesive having greater elastic modulus. When an external force is applied on the such devices, the optical clear adhesive with such property is capable of absorbing most of the external force and decreasing the impact on the such devices from the external force therefore effectively improving the anti-drop strength of the related products and preventing the cover glass or the touch panel from edge breakage and glass debris shatter, reducing the likelihood of personal injury.

It will be apparent to those skilled in the art that various modifications and variations can be made to the disclosed embodiments. It is intended that the specification and examples be considered as exemplary only, with the true scope of the disclosure being indicated by the following claims and their equivalents.

What is claimed is:

1. A touch panel, comprising:
a substrate;
a cover glass disposed above the substrate;
an optical clear adhesive disposed between the substrate and the cover glass, wherein the optical clear adhesive has an elastic modulus ranging from 1×10⁷ Pa to 1×10¹⁰ Pa; and
a touch sensing layer disposed on an upper surface or a lower surface of the substrate or the upper surface and the lower surface of the substrate.

2. The touch panel as claimed in claim 1, wherein the optical clear adhesive comprises adhesive resin material.

3. The touch panel as claimed in claim 1, wherein the optical clear adhesive has stress at yield point greater than 1×10⁷ Pa.

4. The touch panel as claimed in claim 1, wherein the optical clear adhesive has an elongation at break ranging from 100% to 200%.

5. The touch panel as claimed in claim 1, wherein the cover glass and the substrate each respectively comprise glass or sapphire.

6. The touch panel as claimed in claim 1, wherein the optical clear adhesive has an area that is smaller than that of the cover glass.

7. A touch display device, comprising:
a display module;
a touch panel disposed above the display module; and
a first optical clear adhesive disposed between the display module and the touch panel, wherein the first optical clear adhesive has an elastic modulus ranging from 1×10⁷ Pa to 1×10¹⁰ Pa.

8. The touch display device as claimed in claim 7, wherein the first optical clear adhesive comprises adhesive resin material.

9. The touch display device as claimed in claim 7, wherein the first optical clear adhesive has stress at yield point greater than 1×10⁷ Pa.

10. The touch display device as claimed in claim 7, wherein the first optical clear adhesive has an elongation at break ranging from 100% to 200%.

11. The touch display device as claimed in claim 7, wherein the touch panel comprises a cover glass and a touch sensing layer disposed on a lower surface of the cover glass.

12. The touch display device as claimed in claim 7, wherein the touch panel comprises a substrate, a touch sensing layer, a second optical clear adhesive and a cover glass, wherein the touch sensing layer is disposed on an upper surface or a lower surface of the substrate or the upper surface and the lower surface of the substrate, the cover glass is disposed above the substrate, and the second optical clear adhesive is disposed between the substrate and the cover glass.

13. The touch display device as claimed in claim 12, wherein the cover glass and the substrate each respectively comprise glass or sapphire.

14. The touch display device as claimed in claim 12, wherein the second optical clear adhesive has an elastic modulus ranging from 1×10⁷ Pa to 1×10¹⁰ Pa.

15. The touch display device as claimed in claim 12, wherein the second optical clear adhesive has stress at yield point greater than 1×10⁷ Pa.

16. The touch display device as claimed in claim 7, wherein the first optical clear adhesive has an area that is smaller than that of the touch panel.

17. A display device, comprising:
a display module;
a cover glass disposed above the display module; and
an optical clear adhesive disposed between the display module and the cover glass, wherein the optical clear adhesive has an elastic modulus ranging from 1×10⁷ Pa to 1×10¹⁰ Pa.

18. The display device as claimed in claim 17, wherein the optical clear adhesive has stress at yield point greater than 1×10⁷ Pa.

19. The display device as claimed in claim 17, wherein the optical clear adhesive has an elongation at break ranging from 100% to 200%.
